(19) United States
(12) Patent Application Publication
(10) Pub. No.: US 2025/0139899 A1
(43) Pub. Date: May 1, 2025

(54) APPARATUS AND METHOD FOR MANAGING A SPATIAL MODEL AND METHOD THEREOF

(71) Applicants: Korea University Research and Business Foundation, Seoul (KR); TeeLabs Co., Ltd., Seoul (KR)

(72) Inventors: Nak Ju DOH, Seoul (KR); Bum Chul JANG, Seoul (KR); Bo Kyeon JEONG, Cheongdo-gun (KR); Ga Hyeon LIM, Seoul (KR); Hyung A CHOI, Seoul (KR)

(73) Assignees: Korea University Research and Business Foundation, Seoul (KR); TeeLabs Co., Ltd., Seoul (KR)

(21) Appl. No.: 18/893,005

(22) Filed: Sep. 23, 2024

(30) Foreign Application Priority Data
Oct. 26, 2023 (KR) 10-2023-0144329
Jul. 24, 2024 (KR) 10-2024-0097687

(51) Int. Cl. G06T 17/20; G06T 7/70; G06T 7/90; G06V 10/10; G06V 10/44

(52) U.S. Cl. CPC G06T 17/20; G06T 7/70; G06T 7/90; G06V 10/16; G06V 10/44

(57) ABSTRACT

Provided is an apparatus and method for managing a spatial model, and a spatial model management apparatus includes a data collector configured to collect dynamic method data including shape and color information using a dynamic space scanner and to collect static method data including color information using a static space scanner, for an area for which a spatial model is to be produced; a spatial information deriver configured to derive spatial information using the collected dynamic method data or the collected static method data; and a model generator configured to generate the spatial model using at least one or combination of the spatial information derived from the dynamic method data and the spatial information derived using the static method data.

### CROSS-REFERENCE TO RELATED APPLICATION(S)

This application claims priority from and the benefit of Korean Patent Application No. 10-2023-0144329 filed on Oct. 26, 2023 and KR Patent Application No. 10-2024-0097687 filed on Jul. 24, 2024, which are hereby incorporated by reference in its entirety.

### BACKGROUND

### 1. Field

Example embodiments relate to an apparatus and method for managing a spatial model, and more particularly, a technical idea of estimating the pose from which data for deriving spatial information is acquired and using the estimated pose to produce and use a spatial model.

### 2. Related Art

Information on space, such as shape and color, may be called “spatial information.” A device for acquiring a variety of data necessary for deriving spatial information may be called a space scanner.

The space scanner includes a depth data acquisition device, a color data acquisition device, a color-depth data acquisition device, and an supplementary data acquisition device. Also, the space scanner may include the combination of the depth data acquisition device, the color data acquisition device, and the supplementary data acquisition device. The space scanner may provide device information and scan data, such as depth, color, color-depth, and supplementary data, according to combination of configuration devices.

The space scanner may be classified into a static space scanner and a dynamic space scanner according to its operating method.

The static space scanner relates to acquiring data in a stationary state or with a minimal movement, and is mounted on a support and acquires data in a stationary state or with a minimal movement. The static space scanner may be classified into an instantaneous acquisition type and an interval acquisition type according to its operating method. The instantaneous acquisition type refers to a type of instantaneously acquiring data and the interval acquisition type refers to a type of acquiring data over a certain period of time.

The dynamic space scanner refers to acquiring data while moving and is mounted on a moving object, such as a person, a mobile robot, a vehicle, and a drone, and acquires data as the moving object moves. The dynamic space scanner may be classified into a planar movement type and an free movement type according to a type of movement. The planar movement type refers to a case in which it is mounted on a moving object movable only on a plane, such as a vehicle, and the free movement type refers to a case in which it is mounted on a moving object moving in 6 degrees of freedom (6DoF), such as a person and a drone.

Spatial information may be derived based on data collected through the space scanner and the spatial model may be generated based on the spatial information. The spatial model may be expressed in a form of a point cloud, a mesh, an image, and a 360 virtual tour.

The related art of acquiring data with a single space scanner and constructing a spatial model by selecting one of the static space scanner and the dynamic space scanner may have the following issues.

A) In the case of a single space scanner, the target space in which the spatial model may be constructed may be limited.

In particular, to acquire high-quality data, it may be necessary to restrict the movement of a person and an object in a predetermined area around a data acquisition point. In general, the static space scanner rather than the dynamic space scanner and the interval acquisition type static space scanner rather than the instantaneous acquisition type static space scanner may be difficult to use in a space with a lot of movement of people and objects since a relatively large amount of time is required to limit movement per data acquisition point.

Also, to produce the high-quality spatial model, data may need to be acquired meticulously. If data acquisition is difficult for some areas depending on a size, a height, and a shape of the space scanner, use of the corresponding space scanner may be limited.

A bulky space scanner may be difficult to use in a space with many objects or a complex structure and a narrow space.

In the case of a space scanner of which height is limited to a certain range, the space scanner may not be readily used in a space above the limited height. For example, the static space scanner that is used by being mounted on a support with about a height of a person and the dynamic space scanner carried by the hand of the person may not be readily used in a space where the ceilig is roughly open like double-height lobby.

If the space contains an area that is difficult to locate the scanner because of its shape, it may be difficult to use the scanner. For example, in the case of the static space scanner mounted on a ground-mounted support, such as a tripod and a stand, it may be difficult use the same in an area in which the corresponding scanner may not be stably installed, and in the case of the dynamic space scanner mounted on a wheeled mobile robot, it may be difficult to use the same in a non-flat area, such as stairs.

B) In the case of using the dynamic space scanner alone, data is acquired while moving and a blur effect occurs, which may lead to lower quality of acquired color data compared to the static space scanner.

C) In the case of using a single space scanner, production efficiency may be low when partially updating the spatial model.

In particular, when only color information is changed, the existing shape information may not be used and the spatial model may need to be produced by newly deriving all of shape information and color information.

Also, when only some areas are changed, data acquisition and processing may need to be performed not only for the changed areas but also for the entire area including unchanged areas depending on a method of producing the spatial model.

Related patent document includes Korean Patent Registration No. 10-1347450 titled “image sensing method and apparatus using dual camera.”

### SUMMARY

An objective of example embodiments is to provide an apparatus and method for managing a spatial model that may more easily generate a spatial model with a method of complexly using a dynamic space scanner and a static space scanner and estimating the pose from which data for deriving spatial information is acquired.

An objective of example embodiments is to acquire high-quality scan data while minimizing control of real space by complexly using a dynamic space scanner and a static space scanner.

An objective of example embodiments is to perform a thorough scan of real space without blind spots and quickly acquire scan data by complexly using a dynamic space scanner and a static space scanner to generate a high-quality spatial model.

An objective of example embodiments is to more easily update an existing spatial model.

According to an example embodiment, there is provided a spatial model management apparatus including a data collector configured to collect dynamic method data including shape and color information using a dynamic space scanner and to collect static method data including color information using a static space scanner, for an area for which a spatial model is to be produced; a spatial information deriver configured to derive spatial information using the collected dynamic method data or the collected static method data; and a model generator configured to generate the spatial model using at least one or combination of the spatial information derived from the dynamic method data and the spatial information derived using the static method data.

According to an example embodiment, there is provided a spatial model management apparatus including a model receiver configured to receive a spatial model that is desired to update; a data collector configured to collect additional data for updating spatial information using at least one of a dynamic space scanner and a static space scanner, for a partial area or the entire area including area to be updated in an area corresponding to the received spatial model; a spatial information deriver configured to estimate the acquisition pose of the collected additional data through the spatial information derived from the received spatial model and to derive the spatial information based on the estimated acquisition pose; and a model updater configured to update the spatial model by combining the existing spatial information derived from the received spatial model and spatial information derived from the collected additional data.

According to an example embodiment, there is provided an operating method of a spatial model management apparatus, the method including collecting dynamic method data including shape and color information using a dynamic space scanner for an area for which a spatial model is to be produced; collecting static method data including color information using a static space scanner in the area in which the dynamic method data is collected; deriving spatial information using the collected dynamic method data or the collected static method data; and generating the spatial model using at least one or combination of the spatial information derived from the dynamic method data and the spatial information derived from the static method data.

According to some example embodiments, it is possible to more easily generate a spatial model with a method of complexly using a dynamic space scanner and a static space scanner and estimating the pose from which data for deriving spatial information is acquired.

According to some example embodiments, it is possible to acquire high-quality scan data while minimizing control of real space by complexly using a dynamic space scanner and a static space scanner.

According to some example embodiments, it is possible to perform a thorough scan of real space without blind spots and quickly acquire scan data by complexly using a dynamic space scanner and a static space scanner to generate a high-quality spatial model.

According to some example embodiments, it is possible to more easily update an existing spatial model.

Further areas of applicability will become apparent from the description provided herein. The description and specific examples in this summary are intended for purposes of illustration only and are not intended to limit the scope of the present disclosure.

### BRIEF DESCRIPTION OF THE FIGURES

Embodiments will be described in more detail with regard to the figures, wherein like reference numerals refer to like parts throughout the various figures unless otherwise specified, and wherein:

FIG. 1 is a diagram illustrating a spatial model management apparatus according to an example embodiment;

FIG. 2 is a diagram illustrating a spatial model management apparatus according to another example embodiment;

FIG. 3 illustrates examples of a space scanner according to an example embodiment;

FIGS. 4A and 4B illustrate examples of describing a spatial model according to an example embodiment;

FIG. 5 illustrates a spatial information classification process according to an example embodiment; and

FIG. 6 is a flowchart illustrating an operating method of a spatial model management apparatus according to an example embodiment.

### DETAILED DESCRIPTION

Hereinafter, various example embodiments will be described with reference to the accompanying drawings.

The example embodiments and the terms used herein are not construed to limit technology described herein to specific implementations and should be understood to include various modifications, equivalents, and/or substitutions of corresponding example embodiments.

When it is determined that detailed description related to a relevant known function or configuration may make the disclosure unnecessarily ambiguous in describing various example embodiments in the following, the detailed description will be omitted.

The following terms refer to terms defined in consideration of functions of various example embodiments and may differ depending on a user, the intent of an operator, or custom. Accordingly, the terms should be defined based on the overall contents in the present specification.

In relation to explaining drawings, like reference numerals refer to like elements.

The singular forms “a,” “an,” and “the” are intended to include the plural forms as well, unless the context clearly indicates otherwise.

Herein, expressions, such as “A or B” and “at least one of A and/or B,” may include all possible combinations of listed items.

Expressions, such as “first,” “second,” etc., may describe corresponding components regardless of order or importance and may be simply used to distinguish one component from another component and do not limit the corresponding components.

When it is described that one (e.g., first) component is “(functionally or communicatively) connected” or “accessed” to another (e.g., second) component, the component may be directly connected to the other component or may be connected thereto through still another component (e.g., third component).

Herein, “configured (or set) to ˜” may be interchangeably used with, for example, “suitable for ˜,” “having capability of ˜,” “changed to ˜,” “made to ˜,” “capable of ˜,” or “designed to ˜” in a hardware manner or a software manner, depending on situations.

In a situation, the expression “device configured to ˜” may represent that the device is “capable of” interworking with another device or parts.

For example, the phrase “processor configured (or set) to perform A, B, and C” may refer to a dedicated processor (e.g., embedded processor) for performing a corresponding operation or a general-purpose processor (e.g., central processing unit (CPU) or application processor) capable of performing corresponding operations by executing one or more software programs stored in a memory device.

Also, the term “or” represents “inclusive or” rather than “exclusive or.”

That is, unless otherwise stated or clear from the context, the expression “x uses a or b” represents any one of natural inclusive permutations.

In the specific example embodiments, components included in the invention are expressed in singular or plural forms depending on a presented specific example embodiment.

However, the singular or plural expression is appropriately selected for a presented situation for convenience of description. The example embodiments are not construed as being limited to singular or plural components. Even a component expressed in the plural form may be configured in the singular form, or a component expressed in the singular form may be configured in the plural form.

While the present invention is described with reference to specific example embodiments, it will be apparent to one of ordinary skill in the art that various changes and modifications in forms and details may be made in these example embodiments without departing from the technical spirit of the various example embodiments.

Therefore, the scope of the invention should not be defined by the example embodiments and should be defined by the claims and equivalents of the claims.

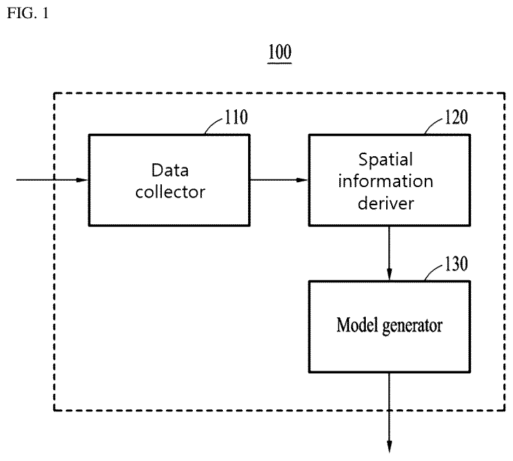

FIG. 1 is a diagram illustrating a spatial model management apparatus 100 according to an example embodiment.

The spatial model management apparatus 100 according to an example embodiment may more easily generate a spatial model with a method of complexly using a dynamic space scanner and a static space scanner and estimating the pose from which data for deriving spatial information is acquired. Also, the spatial model management apparatus 100 may acquire high quality scan data while minimizing control of real space by complexly using the dynamic space scanner and the static space scanner, and may perform a thorough scan of real space without blind spots and quickly acquire scan data by complexly using a dynamic space scanner and a static space scanner to generate a high-quality spatial model. In addition, the spatial model management apparatus 100 may more easily update an existing produced spatial model.

To this end, the spatial model management apparatus 100 according to an example embodiment may include a data collector 110, a spatial information deriver 120, and a model generator 130.

Initially, the data collector 110 according to an example embodiment may collect dynamic method data including shape and color information using the dynamic space scanner and may collect static method data including color information using the static space scanner, for an area for which a spatial model is to be produced.

The spatial information used herein represents information on real space, such as shape and color.

Also, data collected based on the space scanner (also, referred to as space scanner-based collected data) refers to data that is used to derive spatial information and includes device information of the space scanner, scan data that is directly acquired through the space scanner, and preprocessing results using the same.

Therefore, scan data and preprocessing results based thereon excluding the device information from data collected based on the dynamic space scanner may be defined as dynamic method data, and scan data scanner and preprocessing results based thereon excluding the device information from data collected based on the static space may be defined as static method data.

Also, preprocessing represents performing a process of converting a form of scan data before deriving spatial information or calculating additional data from the scan data.

The space scanner refers to a device that acquires a variety of data necessary for deriving spatial information, generally includes a depth data acquisition device, a color data acquisition device, a color-depth data acquisition device, and an supplementary data acquisition device, and provides device information and scan data, such as depth, color, color-depth, and supplementary data, according to a configuration device.

The device information refers to information on a space scanner device. For example, the device information may include a coordinate system of the space scanner, a coordinate system of each component, and a location and direction relationship between the respective coordinate systems.

As the configuration device, the depth data acquisition device, the color data acquisition device, and the color-depth data acquisition device may be included.

Initially, the depth data acquisition device represents a device that provides depth data, the color data acquisition device represents a device that provides color data, and the color-depth data acquisition device represents a device that simultaneously provides color data and depth data.

The supplementary data acquisition device represents a device that provides other types of data other than color data and depth data.

Also, the space scanner may be classified into the static space scanner and the dynamic space scanner according to its operating method.

Initially, the static space scanner refers to a device that acquires data in a stationary state or with a minimal movement. The static space scanner is mounted on a support and acquires data in a stationary state or with a minimal movement.

Also, the static space scanner may be classified into an instantaneous acquisition type and an interval acquisition type according to its operating method.

The instantaneous acquisition type static space scanner refers to a type of instantaneously acquiring data and the interval acquisition type space scanner refers to a type of acquiring data over a certain period of time.

The dynamic space scanner refers to acquiring data while moving and is mounted on a moving object, such as a person, a mobile robot, a vehicle, and a drone, and acquires data as the moving object moves.

Also, a planar movement type dynamic space scanner refers to the dynamic space scanner that is mounted on a moving object movable only on a plane, such as a vehicle.

An free movement type dynamic space scanner refers to the dynamic space scanner that is mounted on a moving object moving in 6 degrees of freedom (6DoF), such as a person and a drone, and the acquisition pose refers to the pose of a device when data is acquired.

In detail, the pose of the space scanner represents origin location information of space scanner coordinate system and direction information of the space scanner coordinate system according to an arbitrarily set reference coordinate system. Also, the acquisition pose of scan data represents the pose of the space scanner when the scan data is acquired. The acquisition pose of preprocessing results may represent the pose of the space scanner that is determined based on the acquisition pose of the scan data used for preprocessing.

An acquisition time represents a time at which each piece of data provided from the scanner is acquired. Each piece of data may not include the acquisition time, may include the acquisition time that follows the same reference time zone, and may also include the acquisition time that follows a different reference time zone.

The spatial model refers to an object that represents real space created based on the spatial information.

As described above, at least one of the dynamic method data and the static method data may include device information of each scanner, scan data, and preprocessing results, and the device information may include the coordinate system of each scanner, the coordinate system of each configuration device, and the location and direction relationship between the respective coordinate systems.

The data collector 110 may collect spatial data including shape and color information using the dynamic space scanner and may collect spatial data including color information using the static space scanner, for the area for which the spatial model is to be produced.

For example, the data collector 110 may collect data including shape and color information using the free movement type dynamic space scanner, and may collect data including color information using the instantaneous acquisition type static space scanner.

Space scanner-based collected data used to derive spatial information may include device information of the space scanner, scan data directly acquired through the space scanner, and preprocessing results based thereon.

The device information may include the coordinate system of the space scanner, the coordinate system of each configuration device, and the location and direction relationship between the respective coordinate systems.

The scan data may vary depending on a configuration device of the space scanner, and may include depth, color, color-depth, and supplementary data. This may be data acquired in the area in which the spatial model is to be produced, or may be data acquired in a separate space for use in a calibration process of determining a location and direction relationship between the configuration devices of the space scanner.

For example, the depth data may be in the form of points that are expressed with depth values or basis vectors of 3DoF, and may be acquired from at least one of a LiDAR sensor, a radar, a sound wave detector (SONAR), an infrared (IR) rangefinder, a time of flight (ToF) rangefinder.

The color data may be in the form of a single image or a plurality of images or a video, and may be acquired from at least one of a standard camera, a wide-angle camera, a 360-degree camera, and a stereo camera. The 360-degree camera or an omni-directional camera refers to a camera with the 360-degree horizontal field of view, for example, Insta360's ONE X2.

The color-depth data may be acquired from at least one device among Kinect, JUMP, PrimeSense, and Project Beyond.

The supplementary data may include inertial information, such as acceleration and angular velocity, acquired from an inertial measurement unit (IMU), a distance-based location to a satellite acquired from a global positioning system (GPS), and the number of wheel rotations acquired from an encoder.

The preprocessing results may include results of performing shape conversation and additional data calculation based on the device information and the scan data before deriving the spatial information.

The data collector 110 according to an example embodiment generates the preprocessing results using at least one of the collected scan data.

When the color data configured as a panoramic image is acquired, the data collector 110 may convert the same to a cube map form. When depth data expressed as a depth value is acquired, the data collector 110 may convert the depth value to point cloud data according to the coordinate system of the space scanner. Also, the data collector 110 may convert the depth value to the point cloud data and then generate new point cloud data through interpolation.

When color data configured as a plurality of image sets each in which a plurality of images forms a single set is acquired, the data collector 110 may generate a panoramic image or a cube map image for each set by stitching images of each set. When color data configured as a plurality of image sets each in which two images form a single set is acquired, the data collector 110 may generate depth data for each set using an image pair.

When color data configured as a plurality of images captured at different locations through a single camera is acquired, the data collector 110 may generate depth data based on an overlapping area between the images. Also, the data collector 110 may estimate a location and direction relationship between the depth data acquisition device and the color data acquisition device through a calibration process based on depth data and color data and may generate the preprocessing results.

The space scanner-based collected data may not include a time at which data is acquired, each piece of data may follow the same reference time zone, and each piece of data may follow a different reference time zone.

Then, the spatial information deriver 120 according to an example embodiment may derive the spatial information using the collected dynamic method data or the collected static method data.

In particular, the spatial information deriver 120 according to an example embodiment may estimate the acquisition pose using the collected dynamic method data or the collected static method data, and may derive the spatial information based on the estimated acquisition pose.

The pose of the space scanner may represent origin location and direction information of the space scanner coordinate system according to an arbitrarily set reference coordinate system. The acquisition pose of scan data may represent the pose of the space scanner when the scan data is acquired, and the acquisition pose of preprocessing results may be determined based on the acquisition pose of the scan data used for preprocessing.

For example, the spatial information deriver 120 according to an example embodiment may estimate the acquisition pose through a prediction process, a correction process, and a loop closure process based on the collected dynamic method data.

For example, when n pieces of dynamic method data are acquired, the spatial information deriver 120 may predict the acquisition pose of k-th dynamic method data based on dynamic method data and acquisition pose pairs up to a (k−1)-th dynamic method data and acquisition pose pair and may correct acquisition poses up to the k-th acquisition pose, using a subsequent k-th dynamic method data and acquisition pose pair. The spatial information deriver 120 may repeatedly perform prediction and correction in single or a plurality of data units for second data to n-th data. Also, when a location at which k-th dynamic method data is collected is within a predetermined range from a location at which dynamic method data of a previous point in time is collected, the spatial information deriver 120 may update the acquisition poses up to the k-th acquisition pose through loop closure.

Also, when dynamic method data includes supplementary data indicating movement of the scanner, the spatial information deriver 120 may predict the k-th acquisition pose by adding the movement estimated with the supplementary data to the (k−1)-th acquisition pose. Also, with the assumption that the dynamic method data includes an acquisition time and the dynamic space scanner moves at a constant speed, the spatial information deriver 120 may calculate a speed through difference in change and acquisition time between the (k−2)-th acquisition pose and the (k−1)-th acquisition pose, and may predict the k-th acquisition pose through the calculated speed and a difference between a (k−1)-th acquisition and a k-th acquisition time. The two methods may also be combined and used.

For example, the spatial information deriver 120 may extract features points from the dynamic method data based on the acquisition pose and then may correct the acquisition pose through comparison between the feature points. For feature point extraction, a dynamic method data and acquisition pose pair from a single viewpoint may be used. Also, a plurality of consecutive viewpoints may be used as a single interval and dynamic method data and acquisition pose pairs within the interval may be synthetically used. The comparison between feature points is not limited to the consecutive viewpoints or intervals, may be performed for all viewpoints or intervals in which the same feature point is extracted.

Also, the spatial information deriver 120 may perform the prediction process, the correction process, and the loop closure process by expressing the acquisition pose as the mean of probability distribution and expressing its reliability as variance of probability distribution. The variance may be expressed as an ellipse and the larger the ellipse, the lower the reliability. This method improves the reliability by estimating the probability distribution during the prediction process and by updating the probability distribution during the correction process and the loop closure process.

The spatial information deriver 120 according to an example embodiment may estimate the acquisition pose of some types in the dynamic method data based on the acquisition pose of different type data.

For example, when the dynamic method data is configured using scan data including depth data, color data, and supplementary data, and preprocessing results including additional color data collected by converting the color data in the scan data, the spatial information deriver 120 may estimate the acquisition pose of the depth data and the supplementary data in the scan data through the prediction process, the correction process, and the loop closure process, and may estimate the acquisition pose of the color data in the scan data from the acquisition pose of the corresponding depth data based on the location and direction relationship between the depth data acquisition device and the color data acquisition device in the device information. Also, the spatial information deriver 120 may estimate the acquisition pose of the additional color data, the preprocessing results, based on the acquisition pose of the corresponding color data.

Also, the spatial information deriver 120 according to an example embodiment may derive spatial information from the dynamic method data based on the estimated acquisition pose.

For example, when depth data is collected as one of the dynamic method data, the spatial information deriver 120 may generate a point cloud that follows a reference coordinate system of the corresponding acquisition pose based on a depth value and the acquisition pose and may derive shape information of the spatial information.

Also, the spatial information deriver 120 may derive color information on a partial area or the entire area within the space based on color data in the dynamic method data and the corresponding acquisition pose.

The spatial information deriver 120 may estimate the acquisition pose of the static method data based on the spatial information derived from the dynamic method data. The spatial information deriver 120 may construct a feature point database by extracting at least one first feature point from the spatial information, and may estimate pose information of the static method data by extracting at least one second feature point from the static method data and by comparing the feature point database and the second feature point.

The spatial information deriver 120 may derive the spatial information from the static method data based on the estimated acquisition pose.

For example, the spatial information deriver 120 may derive color information on a partial area or the entire area within the space based on color data in the static method data and the corresponding acquisition pose.

The spatial information may be used to classify components according to meaning. For example, the spatial information may be classified into ceiling, floor, wall, window, chair, desk, frame, and tree, and used for acquisition pose estimation of the static method data, and may be divided into a background portion and a non-background portion and used to generate a spatial model corresponding to the background portion.

The spatial information may be used to classify components based on one of shape information and color information and may classify the components by complexly using the shape information and the color information. To classify the spatial information according to a component, a deep learning network may be used, and a feature point extracted from the spatial information may be used.

The spatial information may include additionally calculated information in addition to information derived from the static method data or the dynamic method data. For example, when the spatial information includes shape information expressed as a point cloud, the spatial information may include normal information and curvature information of each point calculated based on the cloud point, and may include information on adjacency relationship between points.

The model generator 130 according to an example embodiment may generate the spatial model using at least one or combination of spatial information derived from the dynamic method data and spatial information derived using the static method data.

The model generator 130 according to an example embodiment may generate the spatial model that is an object expressing real space based on at least one or combination of spatial information derived using the dynamic space scanner and spatial information derived using the static space scanner.

For example, the model generator 130 may generate the spatial model based on shape information derived using the dynamic scanner and color information derived using the static scanner.

The model generator 130 may generate the spatial model for both indoor space and outdoor space. The spatial model may also be an object that represents independent indoor space, independent outdoor space, or a space in which indoors and outdoors are connected.

The spatial model may be expressed as at least one or combination of a point cloud, a mesh, an image, and a 360 virtual tour. For example, the spatial model may be expressed in a form of a point cloud form that does not include color or a mesh that does not include texture using only shape information in the spatial information, and may be expressed in a form of a colored point cloud or a mesh that includes texture and 360 virtual tour using shape and color information in the spatial information.

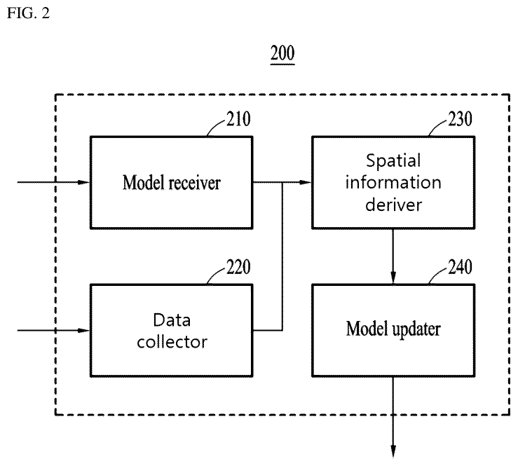

A model updater according to an example embodiment is further described with reference to FIG. 2.

FIG. 2 is a diagram illustrating a spatial model management apparatus 200 according to another example embodiment.

The spatial model management apparatus 200 according to another example embodiment may include a model receiver 210, a data collector 220, a spatial information deriver 230, and a model updater 240.

The model receiver 210 according to an example embodiment may receive a spatial model desired to update. For example, the spatial model for update may be a spatial model generated by the model generator 130 of FIG. 1, or may be a spatial model generated by another spatial model generation device or generation server. This model receiver 210 may receive model data from an external server through a network or may call a model from a local storage.

The data collector 220 according to an example embodiment may collect additional data for updating spatial information using at least one of a dynamic space scanner and a static space scanner, for a partial area or the entire area that includes an area to be updated in an area corresponding to the spatial model.

For example, the data collector 220 may collect additional data for deriving spatial information including shape and color information using an free movement type dynamic space scanner and may collect additional data for deriving spatial information including color information using an instantaneous acquisition type static space scanner.

In this process, the free movement type dynamic space scanner may collect data in real time using mobile equipment, such as a robot or a drone. This dynamic space scanner accurately collects a 3D shape using a LiDAR, a radar, an ultrasonic sensor, and the like.

For example, the data collector 220 may collect additional data for deriving color information of spatial information using the instantaneous acquisition type static space scanner configured with a single 360-degree camera. The 360-degree camera may collect omni-directional color information at a single point, and may quickly verify the overall color arrangement or lighting condition in a space. This data plays an important role in improving visual accuracy of the spatial model.

The spatial information deriver 230 according to an example embodiment may estimate the acquisition pose of additional data collected through spatial information derived from the spatial model. The spatial information deriver 230 may derive the spatial information for update from the collected additional data based on the estimated acquisition pose. For example, in the case of the dynamic method data in the collected additional data, the spatial information deriver 230 may estimate the first acquisition pose of the dynamic method data based on the existing spatial information derived from the spatial model and then may estimate the acquisition pose of the dynamic method data through the prediction process, the correction process, and the loop closure process of FIG. 1.

Also, in the case of the static method data in the collected additional data, the spatial information deriver 230 may perform estimation based on the existing spatial information derived from the spatial model. The spatial information deriver 230 may construct a feature point database by extracting at least one first feature point from the existing spatial information, and may estimate pose information of the static method data by extracting at least one second feature point from the static method data and by comparing the feature point database and a second feature point. In this process, the spatial information deriver 230 may more precisely extract a feature point using deep learning-based image analysis technology and, through this, may further improve accuracy of the spatial model.

The model updater 240 according to an example embodiment may update the spatial model by combining the existing spatial information derived from the spatial model and spatial information for update derived from the collected additional data. In this process, the model updater 240 may integrate existing data and new data using various algorithms and may correct inconsistency. For example, the model updater 240 may analyze a pattern of new data using a machine learning algorithm and may reflect the same to the existing model to improve the model accuracy.

Also, the spatial model may be used by classifying components according to meaning. For example, the spatial information may be classified into ceiling, floor, wall, window, chair, frame, and tree, and used for acquisition pose estimation of the static method data. This classification allows the spatial model to be more systematically managed and a change in a specific element to be more easily identified. Also, the spatial information may be divided into a background portion and a non-background portion and be used to generate a spatial model corresponding to the background portion. Through this, the spatial model may be visually represented with more realistic sense.

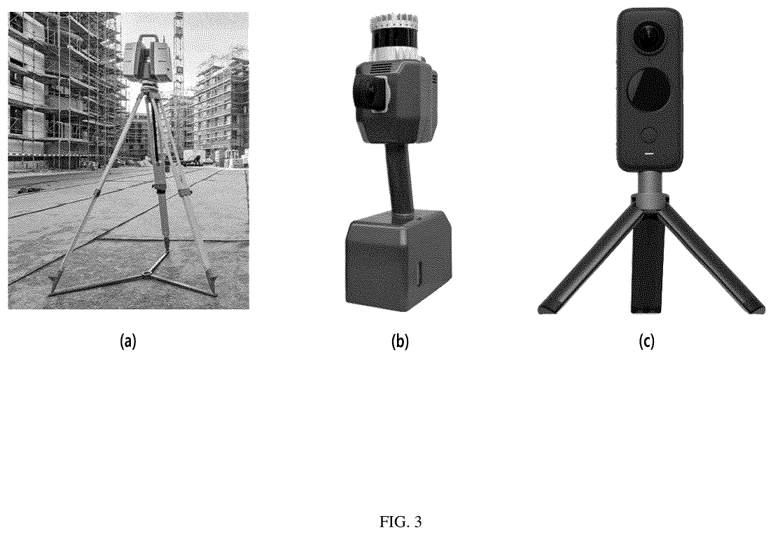

FIG. 3 illustrates examples of a space scanner according to an example embodiment.

Referring to FIG. 3, (a) of FIG. 3 illustrates an example of a static space scanner (e.g., ScanStation P50 from Leica) used to collect static spatial information in a spatial model management apparatus according to an example embodiment or another example embodiment, (b) of FIG. 3 illustrates an example of a space scanner (TeeScanner from TeeLabs) used as an free movement type dynamic space scanner in the spatial model management apparatus according to an example embodiment or another example embodiment, and (c) of FIG. 3 illustrates an example of a static space scanner (Insta 360's ONE X2 mounted on a tripod) used to collect static spatial information in the spatial model management apparatus according to an example embodiment or another example embodiment. Also, (d) of FIG. 3 illustrates an example of a planar movement type dynamic space scanner (robotic scanner from TeeLabs).

The space scanner may be classified into a static space scanner and a dynamic space scanner according to its operating method.

The static space scanner refers to a space scanner that acquires data in a stationary state or with a minimal movement. For example, it may be mounted on a ground-mounted support, such as a tripod and a stand, to acquire data in a stationary state, and may be mounted on a selfie stick or a drone to acquire data while a minimal movement.

The static space scanner may be classified into an instantaneous acquisition type and an interval acquisition type according to its operating method. The instantaneous acquisition type refers to a type of instantaneously acquiring data, and the interval acquisition type refers to a type of acquiring data over a certain period of time. For example, as the interval acquisition type static space scanner, there may be the space scanner as shown in (a) of FIG. 3 that acquires data while rotating, and as the instantaneous acquisition type static space scanner, there may be the space scanner as shown in (c) of FIG. 3 that instantaneously captures a photo.

The dynamic space scanner refers to a space scanner that acquires data while moving and is mounted on a moving object, such as a person, a mobile robot, a vehicle, and a drone, and acquires data as the moving object moves. The dynamic space scanner may be classified into a planar movement type and an free movement type according to a type of movement. The planar movement type refers to a case in which it is mounted on a moving object movable only on a plane, such as a vehicle. The free movement type refers to a case in which it is mounted on a moving object moving in 6DoF, such as a person and a drone.

For example, the planar movement type dynamic scanner may be mounted on a mobile robot as shown in (d) of FIG. 3, and the free movement type dynamic space scanner may be carried by the hand of the person.

In the case of using the dynamic space scanner rather than the static space scanner and using the instantaneous acquisition type static space scanner rather than the interval acquisition type static space scanner, high-quality data may be acquired while minimizing movement restriction per data acquisition point in a space with a lot of movement of persons and objects.

In the case of acquiring color data using the dynamic space scanner, data may be acquired while moving, which may result in blur effect. In the case of using the static space scanner that acquires data in a stationary state or with a minimal movement, high quality color data with small degradation in image quality by the blur effect may be acquired compared to the dynamic space scanner.

The volume and weight of the space scanner may vary depending on a type and the number of configuration devices and an accessible area may vary accordingly. Also, in the case of the static space scanner, the accessible area may vary depending on a type of a support on which the static space scanner is mounted. In the case of the dynamic space scanner, the accessible area may vary depending on a type of a moving object on which the dynamic space scanner is mounted. Here, data may be meticulously acquired in the accessible area without blind spots by complexly using complementary scanners.

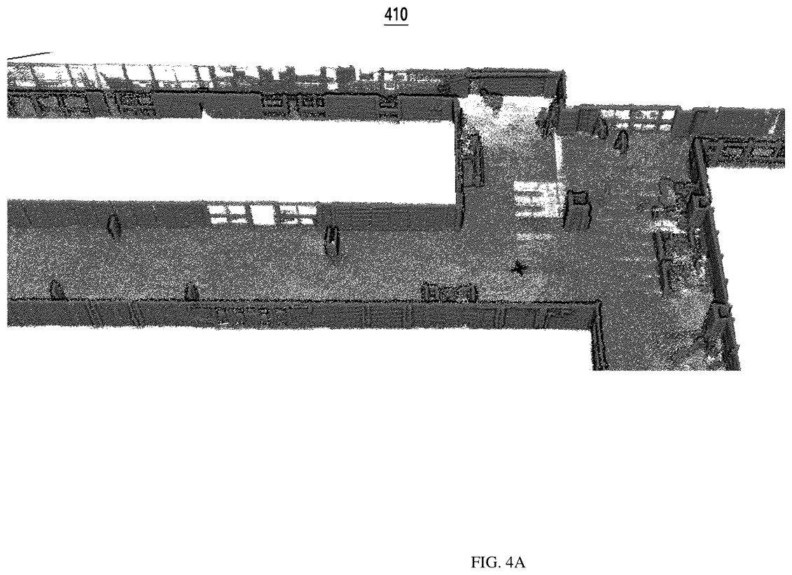

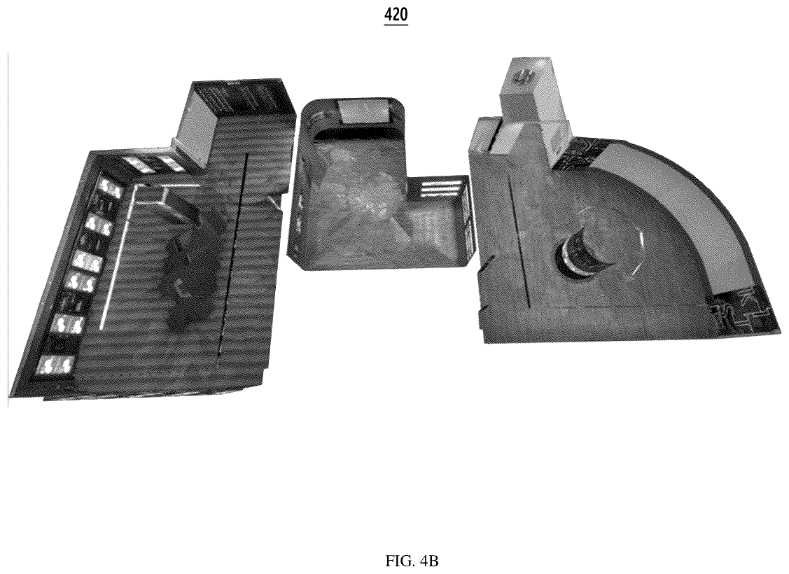

Referring to FIGS. 4A and 4B, a reference numeral 410 refers to a spatial model expressed as a point cloud, and a reference numeral 420 refers to a spatial model expressed in the form of TeeVR that is one of meshes including texture.

The spatial model may be generated using only a portion of spatial information classified into a plurality of components. For example, the spatial model may be generated using only background portion spatial information in the spatial information that is divided into a background portion and a non-background portion.

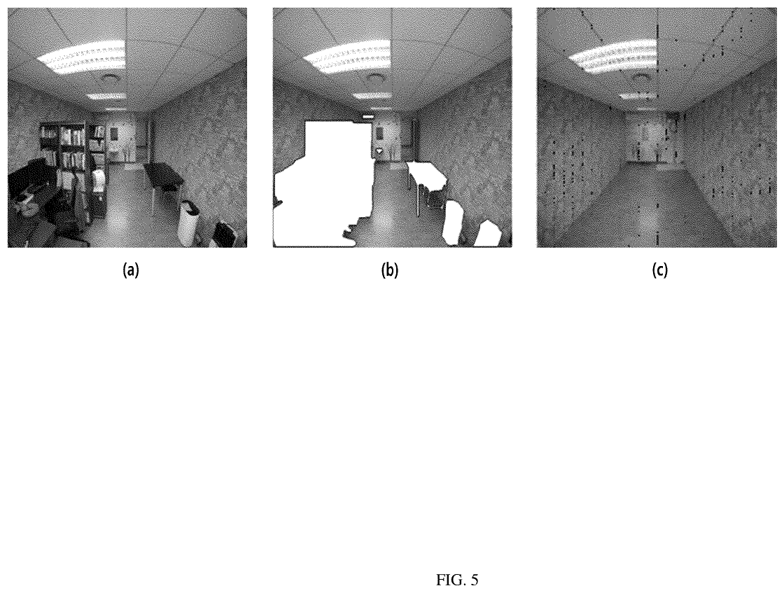

Also, FIG. 5 illustrates a process of distinguishing a background portion and a non-background portion ((b) of FIG. 5) from the entire spatial information ((a) of FIG. 5) and extracting the background portion ((c) of FIG. 5).

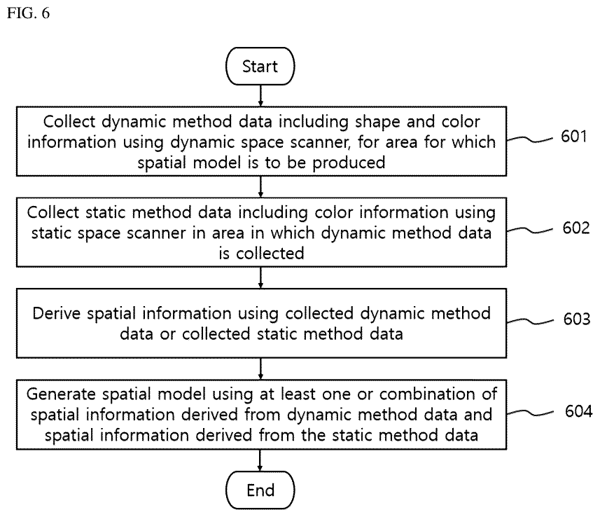

FIG. 6 is a flowchart illustrating an operating method of a spatial model management apparatus according to an example embodiment.

In operation 601, the operating method of the spatial model management apparatus according to an example embodiment may collect dynamic method data including shape and color information using a dynamic space scanner, for an area for which a spatial model is to be produced.

In operation 602, the operating method of the spatial model management apparatus according to an example embodiment may collect static method data including color information using a static space scanner in the area in which the dynamic method data is collected.

Also, in operation 603, the operating method of the spatial model management apparatus according to an example embodiment may derive spatial information using the collected dynamic method data or the collected static method data.

To this end, through a prediction process, a correction process, and a loop closure process, the acquisition pose may be estimated based on the collected dynamic method data and spatial information may be derived using the estimated acquisition pose.

In operation 604, the operating method of the spatial model management apparatus according to an example embodiment may generate the spatial model using at least one or combination of the spatial information derived from the dynamic method data and the spatial information derived from the static method data.

According to example embodiments, it is possible to more easily generate a spatial model with a method of complexly using a dynamic space scanner and a static space scanner and estimating the pose from which data for deriving spatial information is acquired. Also, it is possible to acquire high-quality scan data while minimizing control of real space by complexly using a dynamic space scanner and a static space scanner.

In addition, it is possible to perform a thorough scan of real space without blind spots and quickly acquire scan data by complexly using a dynamic space scanner and a static space scanner to generate a high-quality spatial model, and to more easily update an existing spatial model.

Although the example embodiments are described with reference to the accompanying drawings, it will be apparent to one of ordinary skill in the art that various alterations and modifications in form and details may be made in these example embodiments without departing from the spirit and scope of the claims and their equivalents. For example, suitable results may be achieved if the described techniques are performed in different order, and/or if components in a described system, architecture, device, or circuit are combined in a different manner, and/or replaced or supplemented by other components or their equivalents.

Therefore, other implementations, other example embodiments, and equivalents of the claims are to be construed as being included in the claims.

What is claimed is:

1. A spatial model management apparatus comprising:
a data collector configured to collect dynamic method data including shape and color information using a dynamic space scanner and to collect static method data including color information using a static space scanner, for an area for which a spatial model is to be produced;
a spatial information deriver configured to derive spatial information using the collected dynamic method data or the collected static method data; and
a model generator configured to generate the spatial model using at least one or combination of the spatial information derived from the dynamic method data and the spatial information derived using the static method data.

2. The spatial model management apparatus of claim 1, wherein at least one of the dynamic method data and the static method data includes device information of each scanner, scan data, and preprocessing results, and
the device information includes a coordinate system of each scanner, a coordinate system of each configuration device, and a location and direction relationship between the respective coordinate systems.

3. The spatial model management apparatus of claim 2, wherein the data collector is configured to generate the preprocessing results using at least one of the collected scan data,
when color data configured as a panoramic image is acquired as at least one of the scan data, convert a panoramic form to a cube map form,
when depth data expressed as a depth value is acquired as at least one of the scan data, convert the depth value to point cloud data according to the coordinate system of the space scanner,
when depth data expressed as a depth value is acquired as at least one of the scan data, convert the depth value to the point cloud data according to the coordinate system of the space scanner, and generate new point cloud data through interpolation,
when color data configured as a plurality of image sets each in which a plurality of images forms a single set is acquired as at least one of the scan data, generate a panoramic image or a cube map image for each set by stitching images of each set,
when color data configured as a plurality of image sets each in which two images form a single set is acquired as at least one of the scan data, generate depth data for each set using an image pair,
when color data configured as a plurality of images captured at different locations through a single camera is acquired as at least one of the scan data, generate depth data based on an overlapping area between the images, or
estimate a location and direction relationship between a depth data acquisition device and a color data acquisition device through a calibration process based on depth data and color data in the scan data and generate the preprocessing results.

4. The spatial model management apparatus of claim 1, wherein the spatial information deriver is configured to estimate the acquisition pose using the collected dynamic method data or the collected static method data and to derive the spatial information based on the estimated acquisition pose.

5. The spatial model management apparatus of claim 4, wherein the spatial information deriver is configured to estimate the acquisition pose through a prediction process, a correction process, and a loop closure process based on the collected dynamic method data.

6. The spatial model management apparatus of claim 5, wherein the spatial information deriver is configured to, when n pieces of dynamic method data are acquired, predict the acquisition pose of k-th dynamic method data based on dynamic method data and acquisition pose pairs up to a (k−1) dynamic method data and acquisition pose pair and the k-th dynamic method data,
correct acquisition poses up to the k-acquisition pose, based on the dynamic method data and acquisition pose pairs up to a k-th dynamic method data and acquisition pose pair,
repeatedly perform prediction and correction in single or a plurality of data units for second data to n-th data, and
when a location at which the k-th dynamic method data is collected is within a predetermined range from a location at which dynamic method data of a previous point in time is collected, estimate the acquisition pose of dynamic method data through a process of updating acquisition poses up to the k-th acquisition pose through loop closure.

7. The spatial model management apparatus of claim 4, wherein the spatial information deriver is configured to,
derive the spatial information based on the estimated acquisition pose,
when depth data is collected as one of the dynamic method data, generate a point cloud that follows a reference coordinate system of the corresponding acquisition pose based on the depth value and the acquisition pose, and derive shape information in the spatial information, or
derive the spatial information by deriving color information on a partial area or the entire area within the space based on color data in the dynamic method data and the acquisition pose corresponding to the color data.

8. The spatial model management apparatus of claim 7, wherein the spatial information deriver is configured to
estimate the acquisition pose of the static method data based on the spatial information derived from the dynamic method data,
generate a feature point database by extracting at least one first feature point from the spatial information derived from the dynamic method data and estimate pose information of the static method data by extracting at least one second feature point from the static method data and by comparing the generated feature point database and the second feature point, and
derive color information on the partial area or the entire area within the space based on color data in the static method data and the acquisition pose corresponding to the color data.

9. The spatial model management apparatus of claim 1, wherein the model generator is configured to generate the spatial model including at least one of a point cloud, a mesh, an image, and a 360 virtual tour based on shape information derived using a dynamic space scanner and color information derived using a static space scanner.

10. A spatial model management apparatus comprising:
a model receiver configured to receive a spatial model that is desired to update;
a data collector configured to collect additional data for updating spatial information using at least one of a dynamic space scanner and a static space scanner, for a partial area or the entire area including area to be updated in an area corresponding to the received spatial model;
a spatial information deriver configured to estimate the acquisition pose of the collected additional data through spatial information derived from the received spatial model and to derive the spatial information based on the estimated acquisition pose; and
a model updater configured to update the spatial model by combining the existing spatial information derived from the received spatial model and spatial information derived from the collected additional data.

11. An operating method of a spatial model management apparatus, the method comprising:
collecting dynamic method data including shape and color information using a dynamic space scanner for an area for which a spatial model is to be produced;
collecting static method data including color information using a static space scanner in the area in which the dynamic method data is collected;
deriving spatial information using the collected dynamic method data or the collected static method data; and
generating the spatial model using at least one or combination of the spatial information derived from the dynamic method data and the spatial information derived from the static method data.

12. The method of claim 11, wherein the deriving of the spatial information using the collected dynamic method data or the collected static method data comprises estimating the acquisition pose through a prediction process, a correction process, and a loop closure process based on the collected dynamic method data.
